(19) United States
(12) Patent Application Publication
(10) Pub. No.: US 2002/0081431 A1
(43) Pub. Date: Jun. 27, 2002

(54) Coating for metals and lacquer for producing the coating

(76) Inventor: Christina Schmdt, Siegen (DE)

Correspondence Address: KENYON & KENYON, ONE BROADWAY, NEW YORK, NY, 10004, US

(21) Appl. No.: 09/995,136

(22) Filed: Nov. 26, 2001

(30) Foreign Application Priority Data
Nov. 25, 2000 (DE) 100 58 595.7

(51) Int. Cl. C08G 18/00

(52) U.S. Cl. 428/402; 528/44

(57) ABSTRACT

A coating for metallic substrates includes at least one lacquer layer, and a lacquer is for producing such a coating. The coating, just as the lacquer, includes microcapsules which are partly filled with inhibitors against corrosion and with isocyanates and/or radiation-hardening and/or oxygen-reactive polymers.

### FIELD OF THE INVENTION

The present invention relates to a coating for metals as well as a lacquer for producing the coating.

### BACKGROUND INFORMATION

Metallic substrates are covered with lacquers for protection against rust and other chemical as well as physical influences. By the application of the coating, which may have one or several lacquer layers and further layers, if necessary, it is intended to protect the metallic substrate against these influences, and to reduce and/or slow down the effect of these influences on the coated metallic substrate.

European Published Patent Application No. 0 342 685 describes producing microcapsules, which are filled, for example, with materials that are effective against corrosion. If such microcapsules are added to the lacquer of a coating, the coating as a whole has a better resistance to rusting through.

It is an object of the present invention to provide a coating for metallic substrates which has, in particular, resistance to the effects of rusting through.

### SUMMARY

The above and other beneficial objects of the present invention are achieved by providing a coating for metals and a lacquer for producing the coating as described herein.

According to the present invention, microcapsules are added to one and/or a plurality of layers, which are filled in part by inhibitors, and in another part with moisture-hardening isocyanates and/or polymers reactive to radiation and/or oxygen. If the coating according to the present invention is at least partially damaged, the microcapsules release the substances in them. The release may occur by the microcapsules positioned in the region of the damaged location bursting open or tearing open. The substances sourced in the microcapsules, and issuing from them, cover the damaged location. In addition to the corrosion reducing effect of the inhibitors, the polymer hardens by reacting to moisture or radiation, as the case may be, and thereby additionally inhibits access of corrosion fostering media, whereby the progress of corrosion is at least delayed.

### DETAILED DESCRIPTION

A metallic substrate is provided with a coating. The coating provided for protection of substrate against physical and chemical influences includes several layers. The layer closest to the substrate is a phosphate layer. Following phosphate layer there is a so-called KTL layer (kathodische Tauchlackschicht—cathodic dip painting layer). Next to KTL layer there is a paint layer showing color, which, in turn, is covered on the visible side by a clear coat layer which is harder than it.

Microcapsules are arranged within paint layer. Spherical hollow bodies having an average diameter at or below the μm range are designated as microcapsules. At least in the use of microcapsules within clear coat layer, the diameter of microcapsules may be in the range below the wavelength of visible light, since then no visually noticeable effects appear.

Microcapsules are filled with inhibitors and with curable polymers, or rather their precursor products and/or functionally similarly acting hardening substances. The polymers or substances harden after exiting from microcapsules, e.g., by cross-linking three-dimensionally with one another. The hardening reaction of hardening substances may be supported, activated and/or promoted by moisture and/or radiation and/or oxygen.

Inhibitors may include, for example, benzoates and/or organic, aromatic or aliphatic nitrogen, phosphorus or sulfur-containing organic compounds and/or alcohols and/or ketones and/or aldehydes and/or heterocyclic compounds and/or higher fatty acids, or phosphates, silicates, borates, zirconates, tungstenates and/or molybdates of an alkaline earth and/or heavy metal ion.

Isocyanates, e.g., HDI and/or TDI and/or radiation-hardening and/or oxygen-reactive polymers may be used as hardening polymers or hardening substances, as the case may be.

Some of microcapsules may also be filled with an accelerator. The accelerator supports the reactions of the hardening substances and/or the inhibitors.

The positioning of filled microcapsules is not limited to color-providing paint layer. The filled microcapsules may be provided in each single layer or in a plurality of layers of such a coating. The positioning may be in KTL layer, since this additionally supports the latter's effect.

In the example embodiment, the coating may have a damaged part. Damaged part may be, for example, a crack extending all the way through the outer three layers of coating from the visible side, namely, clear coat layer, color-providing paint layer and KTL layer.

In the region of color-providing paint layer, when damaged part is formed, some of the microcapsules are damaged at the same time, whereby the contents stored in their insides are released. Instead of this, or also in supplement, some microcapsules may also burst open during this, whereby the contents stored in the inside, that is, inhibitors or hardening substances or the accelerants, are released to the crack.

The contents collect in damaged part. Materials are used as inhibitors and hardening substances which decant with respect to one another. Thereby, it is possible that inhibitors collect at the bottom of damaged part by way of forming an inhibitor layer, while above it a hardener layer of hardening substances is formed.

What is claimed is:

1. A coating for a metallic substrate, comprising:
at least one lacquer layer including microcapsules, a first portion of the microcapsules filled with a corrosion inhibitor, a second portion of the microcapsules filled with a hardenable substance.

2. The coating according to claim 1, wherein the hardenable substance includes at least one of an isocyanate, a radiation-hardening polymer and an oxygen-reactive polymer.

3. The coating according to claim 1, wherein the inhibitor includes at least one of a benzoate, an organic nitrogen, an aromatic nitrogen, an aliphatic nitrogen, phosphorous, a sulfur-containing organic compound, an alcohol, a ketone, an aldehyde, a heterocyclic compound, a higher fatty acid, a phosphate of an alkaline earth metal ion, a silicate of an alkaline earth metal ion, a borate of an alkaline earth metal ion, a zirconate of an alkaline earth metal ion, a tungstenate of an alkaline earth metal ion, a molybdenate of an alkaline earth metal ion, a phosphate of a heavy metal ion, a silicate of a heavy metal ion, a borate of a heavy metal ion, a zirconate of a heavy metal ion, a tungstenate of a heavy metal ion and a molybdenate of a heavy metal ion.

4. The coating according to claim 2, wherein the isocyanate includes at least one of HDI and TDI.

5. The coating according to claim 1, wherein the coating includes a cathode dip paint layer, the cathode dip paint layer including the microcapsules as a filler.

6. The coating according to claim 1, wherein a third portion of the microcapsules includes a reaction accelerator.

7. The coating according to claim 6, wherein the reaction accelerator includes an amide.

8. A lacquer for producing a coating for a metallic substrate, comprising:
dispersively distributed microcapsules, a first portion of the microcapsules filled with a corrosion inhibitor, a second portion of the microcapsules filled with at least one of an isocyanate, a radiation-hardening polymer and an oxygen-reactive polymer.

9. The lacquer according to claim 8, wherein the inhibitor includes at least one of a benzoate, an organic nitrogen, an aromatic nitrogen, an aliphatic nitrogen, phosphorous, a sulfur-containing organic compound, an alcohol, a ketone, an aldehyde, a heterocyclic compound, a higher fatty acid, a phosphate of an alkaline earth metal ion, a silicate of an alkaline earth metal ion, a borate of an alkaline earth metal ion, a zirconate of an alkaline earth metal ion, a tungstenate of an alkaline earth metal ion, a molybdenate of an alkaline earth metal ion, a phosphate of a heavy metal ion, a silicate of a heavy metal ion, a borate of a heavy metal ion, a zirconate of a heavy metal ion, a tungstenate of a heavy metal ion and a molybdenate of a heavy metal ion.

10. The lacquer according to claim 8, wherein the isocyanate includes at least one of HDI and TDI.

11. The lacquer according to claim 8, wherein the coating includes a cathodic dip paint layer, the cathodic dip paint layer including the microcapsules as a filler.

12. The lacquer according to claim 8, wherein a third portion of the microcapsules includes a reaction accelerator.

13. The lacquer according to claim 12, wherein the reaction accelerator includes an amide.
